(19) United States
(12) Patent Application Publication
(10) Pub. No.: US 2007/0239674 A1
(43) Pub. Date: Oct. 11, 2007

(54) Method and System for Providing Weblog Author-Defined, Weblog-Specific Search Scopes in Weblogs

(76) Inventor: Richard Gorzela, Andover, MA (US)

Correspondence Address: LOTUS AND RATIONAL SOFTWARE;McGuinness & Manaras LLP, 125 NAGOG PARK, ACTON, MA, 01720, US

(21) Appl. No.: 11/279,372

(22) Filed: Apr. 11, 2006

(51) Int. Cl. G06F 17/30

(52) U.S. Cl. 707/3

(57) ABSTRACT

A system for defining search scopes provided through a Weblog, which a Weblog author is allowed to define publicly available, Weblog-specific search scopes that all users with access to the Weblog can use. In an enterprise Weblog embodiment, such customized, Weblog specific search scopes may advantageously be used to provide searches across author specified content stored within the enterprise. The specific content included in the Weblog author defined, Weblog specific search scopes may, for example, include content repositories specified in one or more Weblog-specific content association features, such as a list of the Weblog author's favorite content repositories, the Weblog author's blogroll, or another Weblog-specific content association. The content repositories specified by the Weblog author for a search scope may further include other individually specified Weblogs, document libraries, discussion forums, collaborative workspaces, etc., as may be accessed over the Web, and/or within local area network controlled by an enterprise associated with the Weblog. A user interface is provided to the Weblog author that allows him or her to define custom search scopes the Weblog. In another aspect of the disclosed system, a user interface is provided that allows readers of the Weblog to rate individual ones of multiple custom search scopes provided through the Weblog, and/or add comments associated with individual ones of the multiple custom search scopes provided through the Weblog.

### FIELD OF THE INVENTION

The present invention relates generally to providing Weblogs, often referred to as “blogs”, and more specifically to a method and system for providing an author defined, Weblog specific search scope to a user of a Weblog.

### BACKGROUND OF THE INVENTION

As it is generally known, the World Wide Web is a major service provided over the Internet, using Web server computer systems that store and disseminate Web pages. Web pages are HTML (HyperText Mark-up Language) documents containing text, graphics, animations and videos, and are accessible via Web browser application programs such as Internet Explorer®, Netscape®, Safari, Opera and Firefox. The browser program renders Web pages it obtains via HTTP (HyperText Transport Protocol) on a display screen. A collection of Web pages makes up a Web site. Weblogs, often referred to as blogs, are an increasingly popular type of Web site. Weblogs are an example of personalized, on-line electronic journals. Weblogs typically contain dated entries, usually presented in reverse chronological order, about a particular topic or individual. Weblogs are associated with and written by one or more contributors, often referred to as bloggers, and referred to herein as “authors”. Weblog entries (also referred to herein as “journal entries”, “postings” or “posts”) contain content defined by a Weblog author, and commentary by other users about the entry, or links to such commentary. Many blogs offer an RSS (Really Simple Syndication) or Atom syndication feed that provides headlines of their latest entries along with URLs to the associated content. Weblog authors often provide publicly available links in features of their Weblog to content they find interesting. In the case of other Weblogs that they find interesting, links to such other Weblogs are often included in a Weblog feature referred to as a Blogroll.

The popularity of Weblogs has increased since Weblog development applications such as Pitas, Blogger and GrokSoup were released. Template-based Weblog software has made it increasingly easy to add entries to a Weblog, while hosting services have made it easy to create and maintain a Weblog. Various implementations of Weblogs can be found on the Web. Some existing Weblog publishing tools are designed for use by the general blogging public, while others are customized for specific blog applications, such as product management, education, etc.

Existing Weblogs often include search interfaces on their “journal pages”, which are the pages that a blog reader is directed to first when they visit a blog, and which typically contain the most recent posts to a blog. Performing a search through the search interface of an existing Weblog typically results in the search being performed either over all content contained within the Weblog, or over the entire Web. Some Weblog implementations permit a Weblog user to search using search scopes that are pre-defined by a hosting entity that hosts the Weblog, and are the same for all Weblogs hosted by that entity. Search scopes provided within existing Weblogs include searches across: 1) all content reachable over an enterprise specific Intranet, 2) all content within Weblogs contained within an associated enterprise, or 3) all content within the entire Web (via Google® or some other Internet search engine). Some existing Weblog systems allow a Weblog reading user to select from among such hosting entity defined search scopes, which are the same for all Weblogs provided by such an entity, and cannot be added to or modified for an individual Weblog by an author of that Weblog.

These existing approaches to providing searches through Weblogs are undesirably limited, especially in view of the powerful content linkages provided through Weblogs. Existing approaches especially fall short with regard to enterprise Weblogs, which are specific to a business enterprise, which may be considered protected resources accessible only to members of the enterprise, and which provide references to enterprise controlled content. Examples of enterprise content referred to using enterprise Weblogs include collaborative work environments sometimes referred to as teamspaces, document libraries, discussion forums, and various other types of enterprise private, and/or enterprise controlled content repositories that are shared by members of the enterprise. An enterprise member user that is reading an enterprise Weblog and that wants to search such enterprise-specific content usually has no option but to go directly to the content repositories themselves, and to search their content directly from that context.

Using existing systems, Weblog authors cannot conveniently or effectively define customized search scopes that are associated with and accessed through their Weblogs. As a result, a Weblog author cannot share customized search scopes that the author has defined. Such a limitation runs counter to the Weblog paradigm of sharing—as in the public sharing of content, favorite Weblogs, favorite links, etc.

For the above reasons and others it would be desirable to have a new system for defining a search scope within a Weblog. The new system should enable Weblog authors the ability to define multiple search scopes over which searches may be performed from within their Weblogs.

### SUMMARY OF THE INVENTION

To address the above described and other shortcomings of prior approaches, a new method and system for defining search scopes that are searchable through a Weblog are disclosed. The disclosed system operates to allow Weblog authors to define publicly available search scopes that all users with access to the Weblog can use. In an enterprise Weblog embodiment, such customized, Weblog specific search scopes may, for example, be advantageously used to provide searches across author specified content stored within the enterprise.

In a first aspect of the disclosed system, a Weblog author defined, Weblog specific search scope for an associated Weblog is provided to all readers of a Weblog. The scope of such a Weblog specific search scope may, for example, cover content specified in one or more Weblog features, such as in a list of the Weblog author's favorite content repositories or in the Weblog author's blogroll, or some other set of content defined within the Weblog. The content repositories specified by the Weblog author for a search scope may further include other content specified by the Weblog author, such as other Weblogs, document libraries, discussion forums, collaborative workspaces, etc., that may be accessed over the Web, and/or within a local area network controlled by an enterprise associated with the Weblog.

In another aspect of the disclosed system, a user interface is provided to the Weblog author that allows him or her to define customized search scopes that may be searched through the Weblog, and that may be shared with other Weblog authors for use in other Weblogs. In another aspect of the disclosed system, a user interface is provided that allows readers of a Weblog to rate custom search scopes provided through the Weblog, and/or add comments associated with custom search scopes provided through the Weblog.

A method of providing an electronic subscription to a search scope is also disclosed. In one embodiment of the disclosed system, a Weblog author is provided a user interface that allows him or her to expose one or more search scopes to other users such that those other users can subscribe to events associated with specific search scopes. Various specific events may result in notification to users that subscribe to a search scope, such as a modification to the search scope, a collection of usage statistics associated with the search scope, and other events. The disclosed system for search scope subscriptions may provide various specific types of electronic subscription feeds, such as those based on RSS, Atom, and others.

Thus there is disclosed a new system for defining search scopes for use within a Weblog. The new system advantageously enables Weblog authors flexibility in defining customized search scopes over which searches are performed from within their Weblogs, enables Weblog users select from and use such search scopes, and allows such search scopes to be shared with other Weblog authors and Weblogs.

### BRIEF DESCRIPTION OF THE DRAWINGS

In order to facilitate a fuller understanding of the present invention, reference is now made to the appended drawings. These drawings should not be construed as limiting the present invention, but are intended to be exemplary only.

FIG. 1 is a block diagram show a number of software and hardware components including an illustrative embodiment of the disclosed system;

FIG. 2 is simplified screen shot showing a portion of a Weblog reader user interface provided by an illustrative embodiment of the disclosed system;

FIG. 3 shows a pull down menu for selecting a search scope that may be provided as part of the Weblog user interface of FIG. 2;

FIG. 4 shows a dialog box that may be provided as a user interface that enables a Weblog reading user to rate and/or comment on one or more search scopes provided through a Weblog;

FIG. 5 is a simplified screen shot showing a portion of a Weblog author's user interface provided by an illustrative embodiment of the disclosed system;

FIG. 6 shows a dialog box that may be provided as a user interface that enables a Weblog author to manage one or more search scopes;

FIG. 7 shows a dialog box that may be provided as a user interface that enables a Weblog author to edit a search scope;

FIG. 8 shows a dialog box that may be provided as a user interface that enables a Weblog author to add a new search scope to their Weblog;

FIG. 9 is a block diagram further illustrating components in and operation of an embodiment of the disclosed system;

FIG. 10 is a flow chart illustrating steps performed by an embodiment of the disclosed system;

FIG. 11 is a simplified screen shot showing a portion of a feed reader user interface used to read electronic subscription feeds including a subscription to at least one search scope;

FIG. 12 is another simplified screen shot showing the portion of the feed reader user interface of FIG. 11, following selection of another search scope event provided to the subscribing user;

FIG. 13 is another simplified screen shot showing the portion of the feed reader user interface of FIG. 11, following entry of a subscription URL for a search scope;

FIG. 14 is a simplified screen shot showing a portion of a Weblog reader's user interface through which at least one search scope subscription feed is provided;

FIG. 15 is a simplified screen shot showing a pop-up window associated with a subscribable search scope; and

FIG. 16 is a flow chart illustrating steps performed in one embodiment of the disclosed system for providing a search scope subscription.

### DETAILED DESCRIPTION OF EXEMPLARY EMBODIMENTS

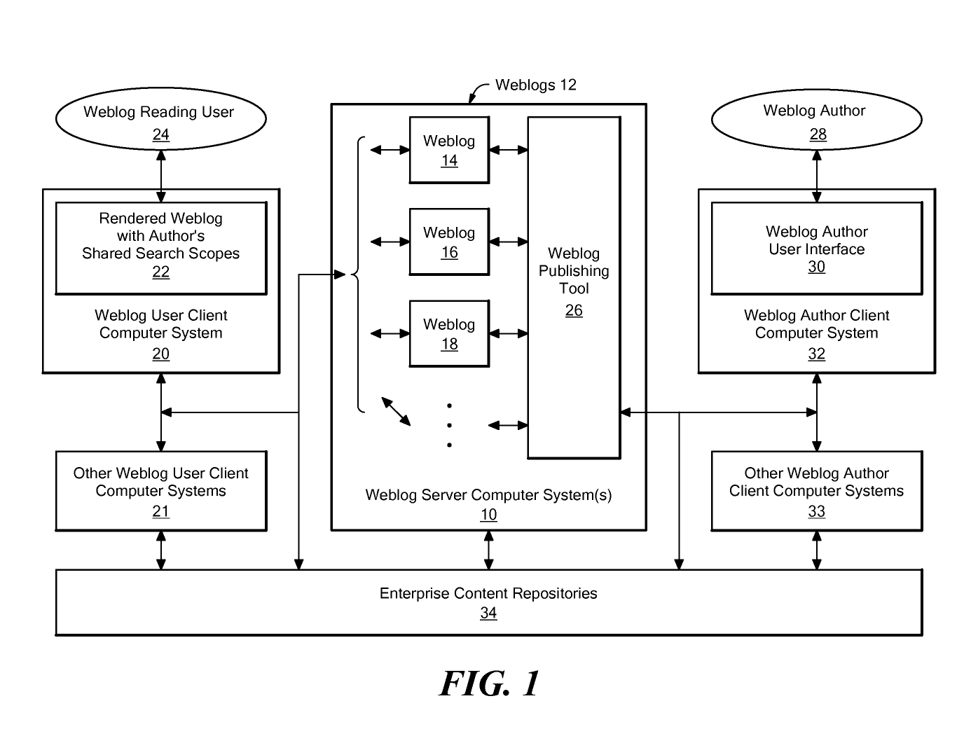

As shown in FIG. 1, software and hardware components in an operational environment of an illustrative embodiment of the disclosed system include a Weblog Server computer system 10, a Weblog Author client computer system 32, and a Weblog User client computer system 20. The Weblog Server computer system 10 includes Weblog Publishing Tool 26, and a number of Weblogs 12, shown for purposes of illustration as including Weblog 14, Weblog 16, Weblog 18, etc. The Weblog Publishing Tool 26 may, for example, be made up of application software executing on the Weblog Server computer system 10. The Weblogs 12 are personalized, on-line journals created through the Weblog Publishing Tool 26, commonly referred to as “blogs”, stored in HTML (HyperText Markup Language) and other specific types of program code, and that may be accessed remotely through the HTTP (HyperText Transfer Protocol) protocol, for example through operation of a Web Server program (not shown) that may also execute on the Weblog Server computer system 10.

Further shown in FIG. 1 are a number of other Weblog User client computer systems 21, other Weblog Author client computer systems 33, and Enterprise Content Repositories 34.

The Weblog User client computer system 20 is shown providing a Rendered Weblog 22 that includes at least one author defined, Weblog specific, shared search scope. The Rendered Weblog 22 may be one of the Weblogs 12, provided to the Weblog User client computer system 20 through operation of a Web Browser application program (not shown), by way of some number of HTTP messages exchanged between the Weblog User client computer system 20 and the Weblog Server computer system 10 over one or more communication networks, such as a local area network (LAN), wide area network (WAN), the Internet, or the like. The Rendered Weblog 22 may similarly be displayed to the Weblog Reading User 26 through such a Web browser program, or through another specific type of Web-enabled program executing on the Weblog User client computer system 20.

The Weblog Author client computer system 32 is shown providing a Weblog Author User Interface 30 that enables the Weblog Author 28 to define at least one author defined, Weblog specific, shared search scope. The Weblog Author User Interface 30 may be provide the Weblog Author 28 with the ability to create, modify, and/or otherwise manage one or more of the Weblogs 12. The Weblog Author User Interface 30 may, for example, be provided to the Weblog Author client computer system 32, from the Weblog Publishing Tool 28, through operation of a Web Browser application program (not shown), by way of some number of HTTP messages exchanged between the Weblog User client computer system 20 and the Weblog Server computer system 10 over one or more communication networks, such as a local area network (LAN), wide area network (WAN), the Internet, or the like. The Weblog Author User Interface 30 may similarly be displayed to the Weblog Author 28 through such a Web browser program, or through another specific type of Web-enabled program executing on the Weblog Author client computer system 32.

The client computer systems 20, 21, 32 and 33, and the server computer system 10 may, for example, each include at least one processor, program storage, such as memory, for storing program code executable on the processor, and one or more input/output devices and/or interfaces, such as data communication and/or peripheral devices and/or interfaces. As mentioned above, the client computer systems 20 and 32, and the server computer system 10 are communicably connected by a data communication system, such as a Local Area Network (LAN), the Internet, or the like. The client computer systems 20 and 32, and the server computer systems 10 may further include appropriate operating system software. While for purposes of clear illustration and concise explanation FIG. 1 specifically shows only one Weblog User client computer 20, one Weblog Author client computer system 32, and one Weblog Server computer system 10, those skilled in the art will recognize that there may be multiple other Weblog User client computer systems 21 and multiple other Weblog Author client computer systems 33, and that Weblog Server computer system(s) 10 may include multiple computer systems, in an operational environment of an embodiment of the disclosed system. Similarly, Enterprise Content Repositories 34 may be stored as data and associated program code in any specific number of additional computer systems accessible through an enterprise controlled communication network to which the systems and/or users of FIG. 1 may be connected and provided access.

During operation of the components shown in FIG. 1, the Weblog Author 28 uses the Weblog Author User Interface 30 provided from the Weblog Publishing Tool 26 to define and manage one or more Weblog author defined, Weblog specific search scopes, that are then published to Weblog reading users through one or more of the Weblogs 12. The Weblog Reading User 24 is then able to use these search scopes provided through one of the Weblogs 12 in order to search the content associated with the search scopes by the Weblog Author 28. In a configuration in which the Weblog Reading User 24 and Weblog Author 28 are members of a business enterprise or organization that controls the Enterprise Content Repositories 34, such content may include enterprise content stored in the Enterprise Content Repositories 34, such as collaborative work environments referred to as teamspaces, document libraries, discussion forums, and various other specific types of enterprise controlled content shared by members of the enterprise.

The disclosed system enables the Weblog Reading User 24 to rate and/or comment on the Weblog author defined, Weblog specific search scopes using an interface provided through the Rendered Weblog 22. The search scopes defined by the Weblog Author 28 through the Weblog Author user interface 30 may be made available to and shared with other Weblog Authors through the Weblog Publishing Tool 26, for use within other ones of the Weblogs 12.

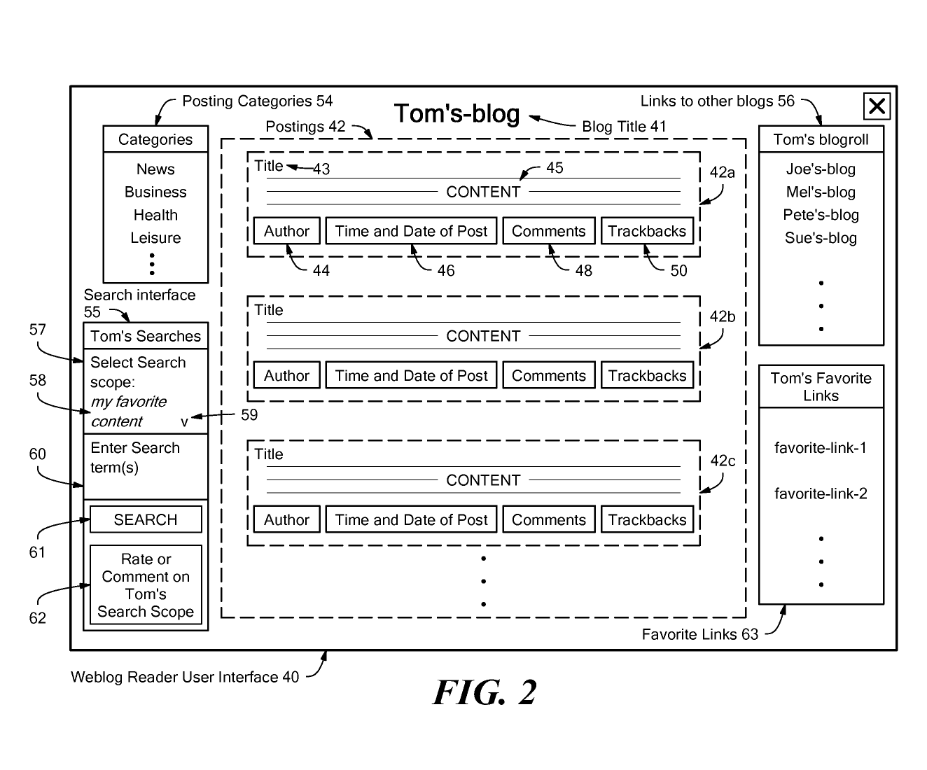

FIG. 2 is simplified screen shot showing a portion of a Weblog user interface 40 provided by an illustrative embodiment of the disclosed system. The Weblog Reader user interface 40 is an example of the Rendered Weblog 22 of FIG. 1. The Weblog user interface 40 is an example of a graphical user interface providing access to one of the Weblogs 12 of FIG. 1, which are electronic, on-line journals. For example, the interface 40 may include one or more Web pages rendered to a user through a Web browser application program or the like. The Weblog Reader user interface 40 is provided by a Weblog to users that request access to the Weblog, but that are not authors of the Weblog. For example, a given Weblog may have associated with it one or more author users, while all other users are provided access to the Weblog through the user interface 40 of FIG. 2.

The user interface 40 includes a blog title 41, in this case “Tom's-blog”. A number of postings 42 are shown for purposes of illustration including a first posting 42a, a second posting 42b, a third posting 42c, and so on. The postings 42 are listed in reverse chronological order. As illustrated in the posting 42a, each posting includes an author indication 44, such as a button through which a link may be accessed to information regarding the author of that posting. A time and date of post indication 46 is provided to display the time and date that the posting was made. A comments button 48 provides the user with a link to comments on the posting. The user can click on the comments button 48 to access previous comments regarding the posting, or to enter their own comment on the posting. A trackbacks button 50 enables the user to access a listing of other Weblogs that include links back to the posting. The title 43 of the posting is entered by the posting's author, and content 45 of each posting may consist of text, graphics, or any other type of content that may be provided over the Web.

The interface 40 is further shown including a postings category interface 54 that is a Weblog feature allowing a user to click on a category name contained from within the category interface 54 to access postings within the Weblog related to that category. A blogroll 56 contains a list of links to other Weblogs selected by the author of the Weblog, such that each of those other Weblogs can be accessed by clicking on a corresponding link within the blogroll 56. A favorite links interface 63 includes a list of links to other content selected by the Weblog author, allowing such selected content to be accessed by clicking on a corresponding link within the favorite links interface 63.

The postings categories 54, blogroll 56, and favorite links interface 63 are examples of Weblog features that enable a Weblog author to share specified content through the Weblog in an organized manner. Such Weblog features enable a Weblog reader to click each item they contain to obtain access to content selected by the Weblog author to be associated with that item. In addition to the Weblog features 54, 56 and 63 of FIG. 2, many other specific types of Weblog features may be provided in embodiments of the disclosed system. These include a Weblog archives interface having entries that are each associated with Weblog postings made within a discrete corresponding time period, and various content feeds, such as those provided through RSS (“RDF Site Summary”, or “Rich Site Summary”) technology, which is an XML (eXtensible Markup Language) format for syndicating Web content.

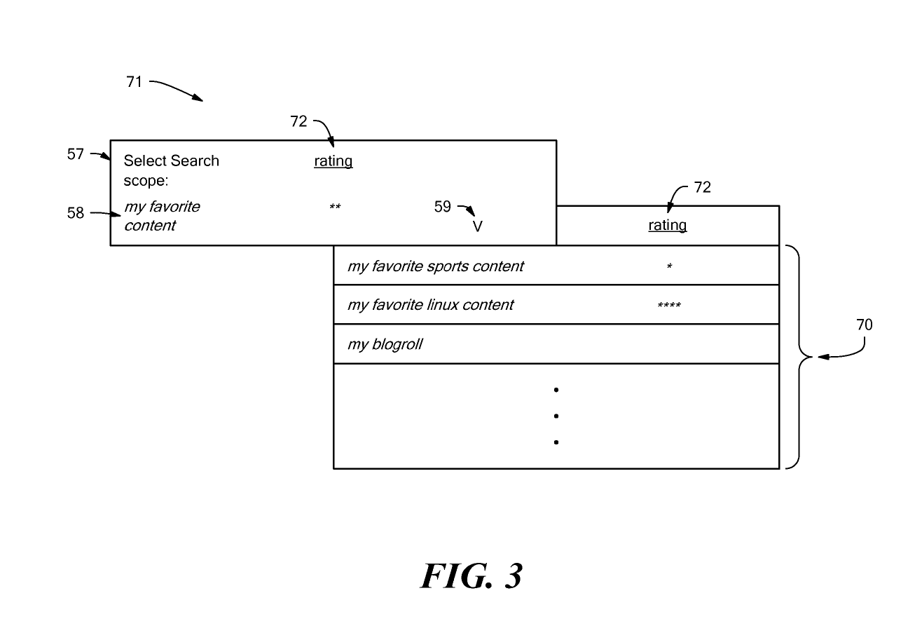

The search interface 55 of the Weblog user interface 40 shown in FIG. 2 enables a user to issue searches using one of a number of search scopes that are specific to the Weblog represented by the Weblog user interface 40, and that were defined by the author of that Weblog. The search scope selector 57 shows a currently selected search scope 58, for purposes of illustration consisting of a search scope having the name “my favorite content”. A down arrow 59 enables the user to access a pull down menu of search scopes to select from, as further illustrated in FIG. 3. A search term interface 60 is provided for the user to enter their search terms, and a button 61 causes a search to be performed based on those search terms, over the content specified by the Weblog author to be associated with the currently selected search scope 58. The results of the search may be provided to the user in any specific fashion, as may be appropriate for a given embodiment or configuration, such as within a list, pop-up window, etc.

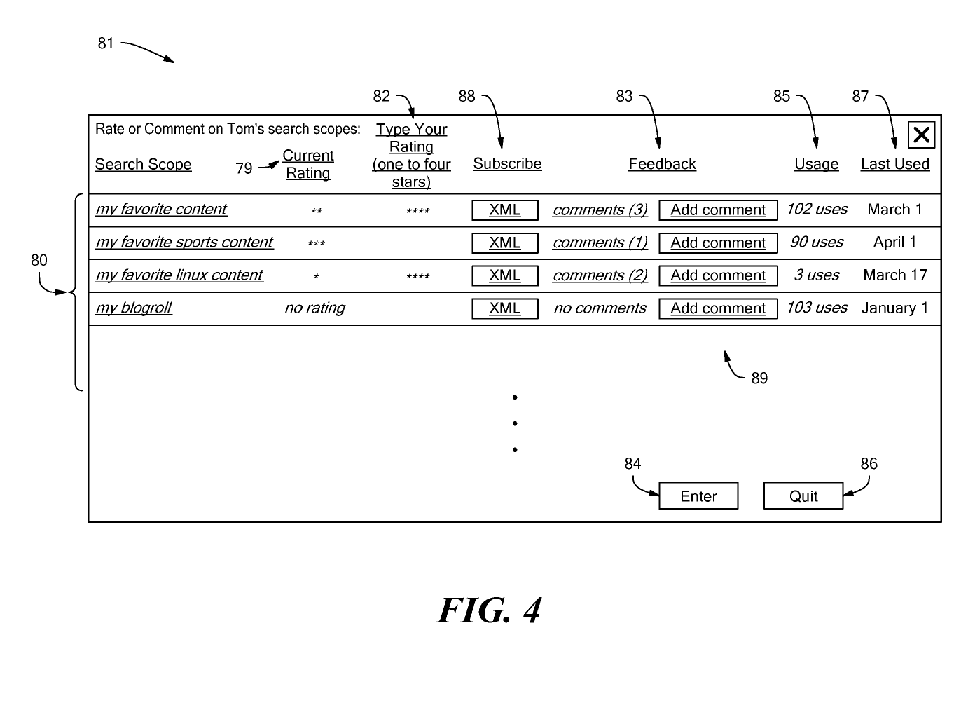

The Weblog user interface 40 further includes a button 62 that enables a reader of the corresponding Weblog to rate and/or comment on one or more of the search scopes that can be selected from the pull down menu accessed through the down arrow 59. A resulting pop-up window user interface resulting from clicking on the button 62 is shown in FIG. 4.

Those skilled in the art will recognize that the specific layout and contents of the Weblog user interface 40 in FIG. 2 are given solely for purposes of explanation, and that many other alternative configurations, layouts, and contents are possible for a specific Weblog. Accordingly, the present invention is not to be considered limited to use with only those Weblogs that match the user interface 40, but rather may be used to provide Weblog specific, Weblog author defined search scopes through any specific formatted Weblog, containing any specific type of content.

FIG. 3 shows a pull down menu 71 for selecting a search scope provided as part of the Weblog user interface 40 of FIG. 2. As shown in FIG. 3, when the user clicks on the down arrow 59, a list 70 of selectable search scopes is displayed. The user can then select one of the search scopes in the list 70 by clicking on the desired search scope. In response to the user clicking on one of the search scopes in the list 70, the currently selected search scope 58 is updated to reflect the user's selection. For example, if the user were to click on the search scope “my blogroll” in the list 70, then the currently selected search scope 58 would be changed to “my blogroll”, and the search scope “my favorite content” would be moved to the list 70.

The pull down menu 71 further displays a ratings column 72 for the currently selected search scope 58 and the search scopes listed in the list 70. Each value in the ratings column 72 reflects a cumulative rating for the corresponding search scope in the list 70, provided by users of the Weblog. Those skilled in the art will recognize that various techniques may used to enable a user to select a specific search scope, and/or to view user ratings associated with specific search scopes, and that the pull down menu 71 and stars-based ratings representations of FIG. 3 are only possibilities in this regard.

FIG. 4 shows a pop-up dialog box 81 that may be provided as a user interface enabling a Weblog reading user to rate and/or comment on one or more search scopes provided through a Weblog. The dialog box 81 further provides the Weblog reading user with statistics information regarding search scopes provided through a Weblog, and access to the comments of other users.

As shown in FIG. 4, the dialog box 81 includes a list 80 of search scopes, and displays a current rating for each of the search scopes in the list 80 in column 79. The dialog box 81 further enables the user to type a rating for one or more of the search scopes in the list 80 into a column 82. Comments by users on the search scopes in the list 80 are accessible through the column 83, which also includes add comment buttons 89 that allow the user to add comments to the corresponding search scopes. A column 85 displays the number of times each search scope has been used to generate a search, and a last used column 87 indicates the last time each search scope was used. Various other specific usage statistics regarding the search scopes in the list 80 may additionally or alternatively be displayed in the dialog box 81.

After the user has finished entering ratings and/or comments for one or more of the search scopes in the list 80, they can click on the enter button 84 to send the ratings and/or comments to be stored in association with the corresponding search scopes. The stored ratings may then be used to generate cumulative ratings to be displayed to users of the Weblog, such as through the column 79, and/or through column 72 shown in FIG. 3. Otherwise, if no ratings and/or comments are to be entered, the user can click on the quit button 86 to close the dialog box 81 without any ratings or comments being stored.

While a star rating system is shown for purposes of illustration in the embodiment of FIG. 4, those skilled in the art will recognize that this is only one example of how user ratings of search scopes may be entered and/or represented. For example, the search scope ratings used by an embodiment of the disclosed system may alternatively use a numerical rating system, smiling or frowning face graphics, or any other rating representation that may be appropriate for a given embodiment.

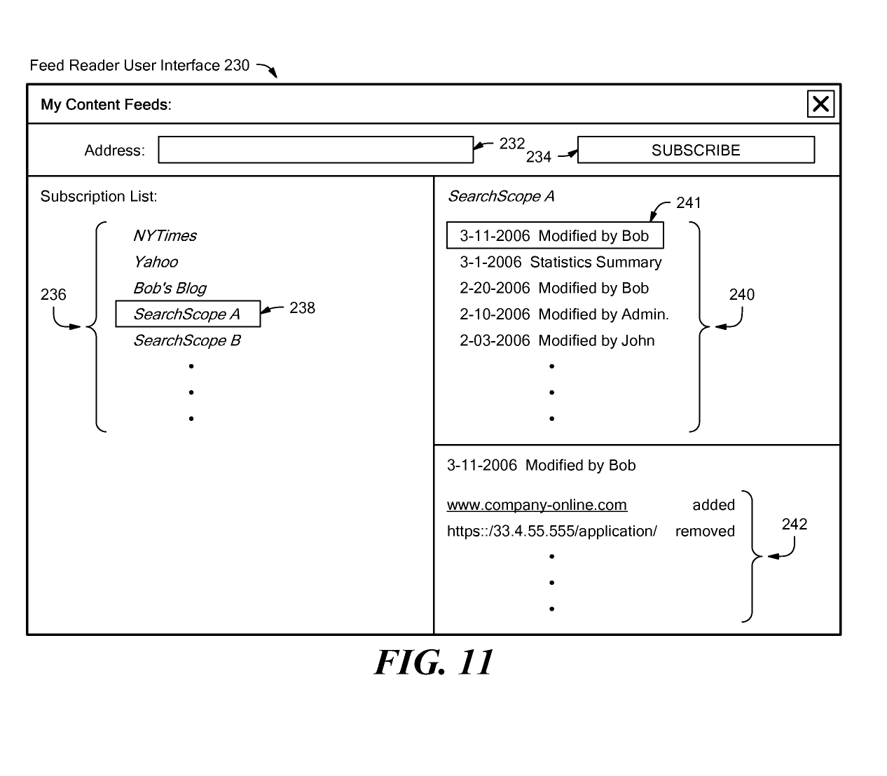

Another feature that may be provided in an embodiment of the disclosed system is providing feeds for a Weblog Author's Weblog search scopes. In such an embodiment, RSS feeds or the like would provide subscribers to a given feed with indications of whether a new search scope has been defined for a given Weblog, if an existing search scope has been updated, etc. In addition, feeds could be used to provide indications to subscribers of other information associated with search scopes, such as the latest usage statistics, including number of times a search has been used, the last time it was used, etc. In this regard, the dialog box 81 of FIG. 4 further includes a subscription column 88 having buttons for each of the search scopes in the list 80. In the example of FIG. 4, when a user clicks on one of the buttons in column 88, they are presented with a URL that can be cut and pasted into an address field of a feed reader program, such as the address field 232 shown in FIG. 11. The URL provided in this way points to a feed of information related to the corresponding search scope, and provided in a format such as RSS or Atom. When loaded into a feed reader application program, sometimes referred to as a feed viewer program, the URL enables the user to access events included in the content feed for a search scope.

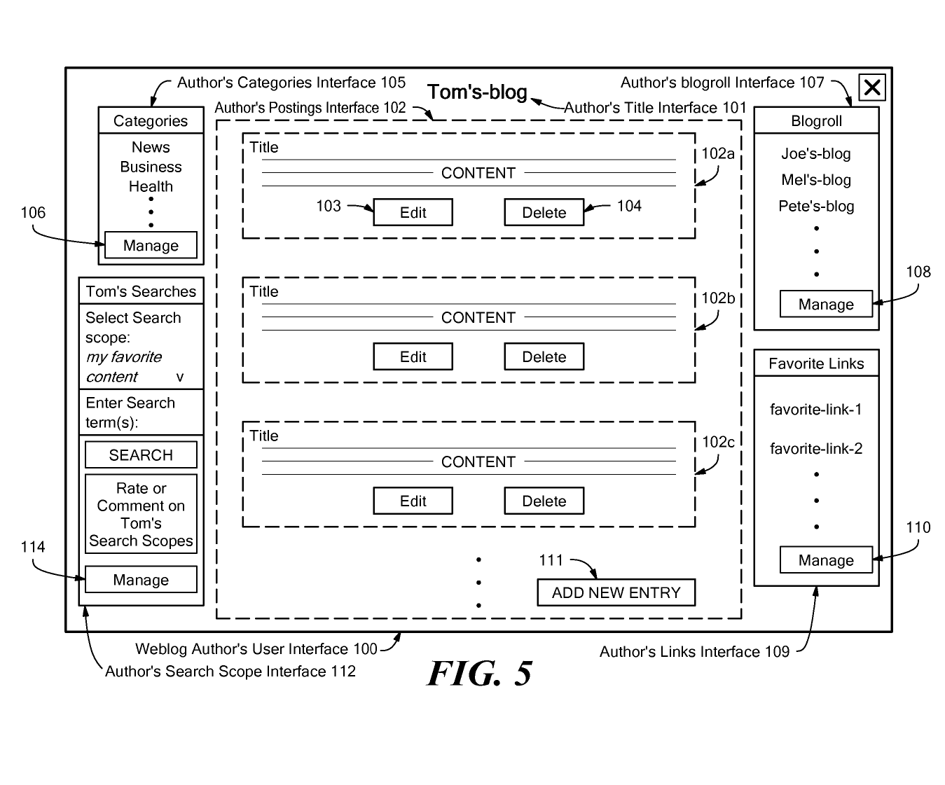

FIG. 5 is a simplified screen shot showing a portion of a Weblog Author's user interface 100 provided by an illustrative embodiment of the disclosed system. The user interface of FIG. 5 may, for example, correspond to the Weblog Author user interface 30 shown in FIG. 1. The user interface 100 is only accessible to authors of the corresponding Weblog, and an appropriate authentication process may be employed to validate a given user as an author prior to displaying the user interface 100.

As shown in FIG. 5, the Weblog Author's user interface 100 may include an Author's Title Interface 101 that enables the Weblog Author to edit the Weblog's title. The Author's Postings Interface 102 enables the Weblog Author to edit and delete journal entries shown including entries 102a, 102b, 102c, etc., using the Edit and Delete buttons 103 and 104 of entry 102a, which are similarly provided for each journal entry. A button 111 further enables the Weblog Author to create a new journal entry.

The Author's Categories Interface 105 enables the Weblog Author to manage the Posting Categories feature of the Weblog. For example by clicking on the manage button 106, the Weblog is provided with the ability to create or delete categories, and/or to associate or disassociate specific content with individual ones of the content categories available through the Posting Categories interface 54 shown in FIG. 1. Similarly, in the Author's blogroll Interface, the Weblog Author is provided with a button 108 that enables the Weblog Author to manage the blog pointers in the blogroll 56 shown in FIG. 1. For example, the button 108 may provide the Weblog Author with the ability to add, modify or delete individual blog pointers within the blogroll 56 of FIG. 1. The button 110 enables the Weblog author to add, modify or delete links contained in the favorite links feature 63 shown in FIG. 1. In the same way, if the Weblog Author clicks on the button 114 in the Authors Search Scope interface 112, then the disclosed system enables the Weblog Author to manage a number of Weblog specific, Weblog author defined search scopes, as further described below.

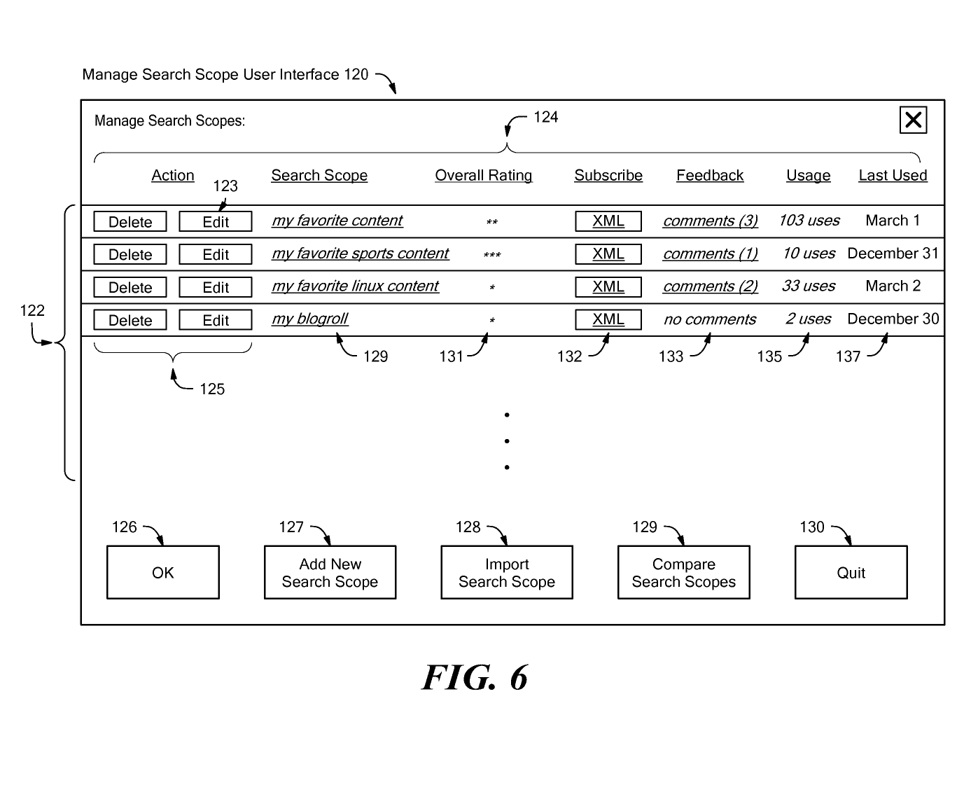

FIG. 6 shows a dialog box 120 that may be provided as a user interface that enables a Weblog author to manage one or more search scopes, for example in response to the Weblog Author clicking on the button 114 of FIG. 5. As shown in FIG. 6, a search scope management interface 120 includes a list 122 of entries, each corresponding to a Weblog specific, Weblog Author defined search scope. In addition to the Weblog specific, Weblog Author defined search scopes in the list 122, one or more partially or completely pre-defined default search scopes may also be automatically provided for selection and use by Weblog Authors not wishing to completely define all their own search scopes from scratch.

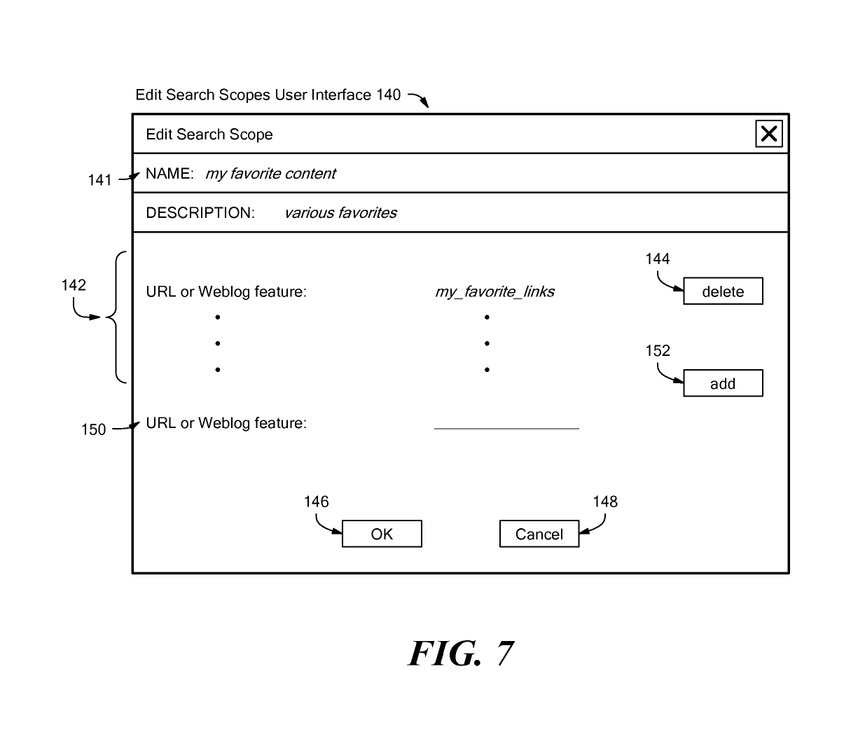

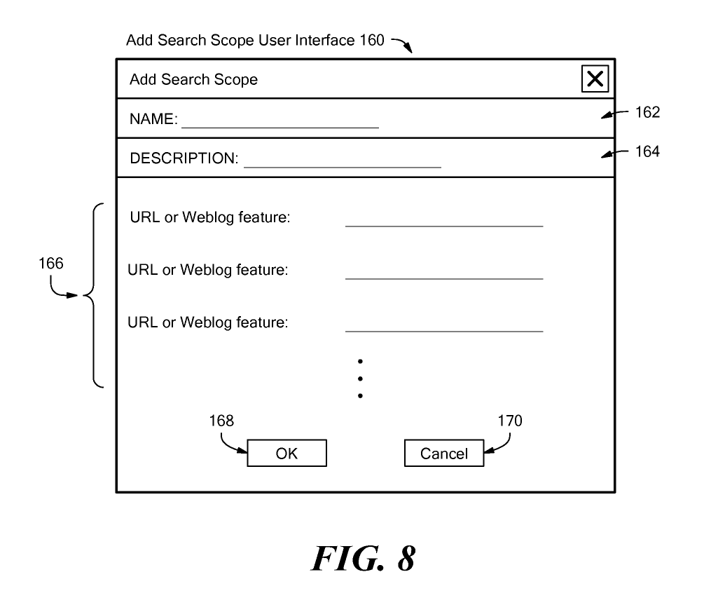

Each entry in the list 122 includes a number of columns 124 of information regarding the corresponding search scope. For example, the name of the search scope is contained in column 129, the overall rating of the search scope is represented in column 131, access to comments received on the search scope is provided through a link contained in column 133, the number of times the search scope has been used is displayed in column 135, and the date and/or time that the search scope was last used is shown in column 137. The delete and edit buttons in column 125 enable the Weblog Author to delete or edit each search scope. Clicking on the OK button 126 causes any changes made to the search scopes to be stored by the Weblog, while clicking on the quit button 130 causes the dialog box 120 to close without any changes being stored. When the Weblog Author clicks on one of the edit buttons in the column 125, such as the button 123 for the first entry, then a display such as that shown in FIG. 7 is generated. When the Weblog Author clicks on the button 127 to add a new search scope, then a display such as that shown in FIG. 8 is generated. When the Weblog Author clicks on the button 128, the disclosed system provides a pop-up window into which allows the Weblog Author to select an importable search scope to be added to the list 122. The importable search scope provided through the button 128 may, for example, be one defined by another Weblog Author for another Weblog, and made available for sharing between Weblogs by the Weblog Publishing Tool 26 of FIG. 1.

If the Weblog Author clicks on the button 129, then the disclosed system generates a user prompt for entry of a search scope to be compared with a currently selected one of the search scopes 122. The disclosed system then operates to compare the two indicated search scopes to identify and display an indication of any content that is not included in both.

Various other features may be provided through the user interface 120. For example, the disclosed system may be embodied to allow author or reading users to tag search scopes for later reference. In such an embodiment, the disclosed system would provide an interface that allows the Weblog author to associate a search scope with a “permalink”, which is a unique URL that remains permanent for that search scope. For example, such a permalink may be made up of a base URL combined with elements such as date, time, names and numbers, or just a unique number. The Weblog associated with the search scope in such an embodiment could use an index to keep track of the location of the search scope, and convert the permalink to that address as needed. Such an embodiment would provide users with the ability to find search scopes via a social bookmarking system such as delicious.

The dialog box 120 of FIG. 6 further includes a subscription column 132 having buttons for each of the search scopes in the list 80. In the example of FIG. 6, when a user clicks on one of the buttons in column 132, they are presented with a URL that can be cut and pasted into an address field of a feed reader program, such as the address field 232 shown in FIG. 11. The URL provided in this way points to a feed of information related to the corresponding search scope, and provided in a format such as RSS or Atom. When loaded into a feed reader application program, sometimes referred to as a feed viewer program, the URL enables the user to access events included in the content feed for a search scope.

FIG. 7 shows a dialog box 140 that may be provided as a user interface that enables a Weblog author to edit a search scope. The dialog box 140 includes a name field 141 that displays the name of the search scope being edited. A description associated with the search scope is displayed in the field 143. A list 142 of URLs (Uniform Resource Locators) or Weblog feature names specifies the content associated with the search scope, thus indicating the content to be searched by searches performed using the search scope. The user interface 140 enables the Weblog Author to delete URLs or Weblog feature names from the list 142, for example using a delete button such as the delete button 144. The user interface 140 further enables the Weblog Author to add URLs or Weblog features to the list 142, for example by typing the URL, or a Weblog feature name, such as a name associated with a blogroll of the Weblog, a name associated with the Favorite Links feature of the Weblog, a name associated with a content feed, or a name associated with some other Weblog feature, into the entry 150 and clicking on the add button 152.

In one embodiment, a unique feature name is associated with each Weblog feature, such as my_categories for the Categories feature 54 of FIG. 2, my_blogroll for the blogroll 56 of FIG. 2, and my_favorite_links for the favorite links feature 63 of FIG. 2, etc. Including a feature name in the definition of a search scope causes all content indicated by the corresponding Weblog feature to be included in the search scope. Accordingly, the inclusion of my_favorite_links in the my_favorite_content search scope being edited in the example of FIG. 7 indicates that all content pointed to by the links contained in the favorite links feature 63 of FIG. 2 is part of the search scope named my_favorite_content.

The disclosed system may further be embodied such that a unique name is provided indicating all the content of postings within the Weblog. For example, the name current_postings may be included in a search scope definition to indicate that the current contents of all postings within the Weblog are to be included in the search scope. Another unique name may be provided indicating all content of the current postings within the Weblog together with all content indicated by links contained in those postings. For example, the name current_postings_and_linked_content may be included in a search scope definition to indicate that the current contents of all postings within the Weblog and all content indicated by links contained in those postings are to be included in the search scope.

Other unique names may be associated by the disclosed system with specific corresponding data repositories, such as data repositories such as document libraries, team spaces, etc., contained in the Enterprise Content Repositories 34 of FIG. 1. For example, a unique name HR_procedures may be provided indicating a database or the like storing documents describing human resources procedures for a business organization associated with the Enterprise Content Repositories 34.

When the Weblog Author is finished editing the search scope, they can click on the button 146 to save the changes. Clicking on the cancel button 148 exits the dialog box 140 without making any changes to the search scope.

FIG. 8 shows a dialog box 160 that may be provided as a user interface that enables a Weblog Author to add a new search scope to their Weblog. To create a search scope, the Weblog Author enters a search scope name into the name field 162. If the name entered into the name field 162 matches a name associated with a previously defined search scope, either by the Weblog Author within the current Weblog, by the Weblog Author in another Weblog, or by a different Weblog Author in the same or a different Weblog, then the disclosed system may be embodied to fill in the details of the search scope definition in the user interface 160 with the previous definition for the search scope. This feature enables search scopes to be shared between and across Weblogs, and between different Weblog Authors.

A description field 164 enables the Weblog Author to enter a definition for the new search scope, or displays the definition read from a previously entered definition matching the search scope name in the name field 162. A list entry form 166 enables the Weblog Author to enter URLs or Weblog feature names that describe the content to be searched when searches are performed using the search scope. For example, the Weblog Author can enter a URL that points to Web content to be included in the search scope. Additionally, as described above with reference to FIG. 7, the Weblog Author can enter a unique name associated with a Weblog feature, such as a name associated with a blogroll of the Weblog, the Favorite Links feature of the Weblog, a content feed, or some other Weblog feature, into one of the entries in the list 166. Accordingly, if the Weblog Author entered the name my_blogroll into an entry within the list 166, the disclosed system would associate all the content within the Weblogs listed in the blogroll of the Weblog with the search scope being added through the user interface 160. Similarly, if the Weblog Author entered my_favorite_links into an entry within the list 166, the disclosed system would associate all the content indicated by URLs contained in the Favorite Links feature of the Weblog with the search scope being added through the user interface 160.

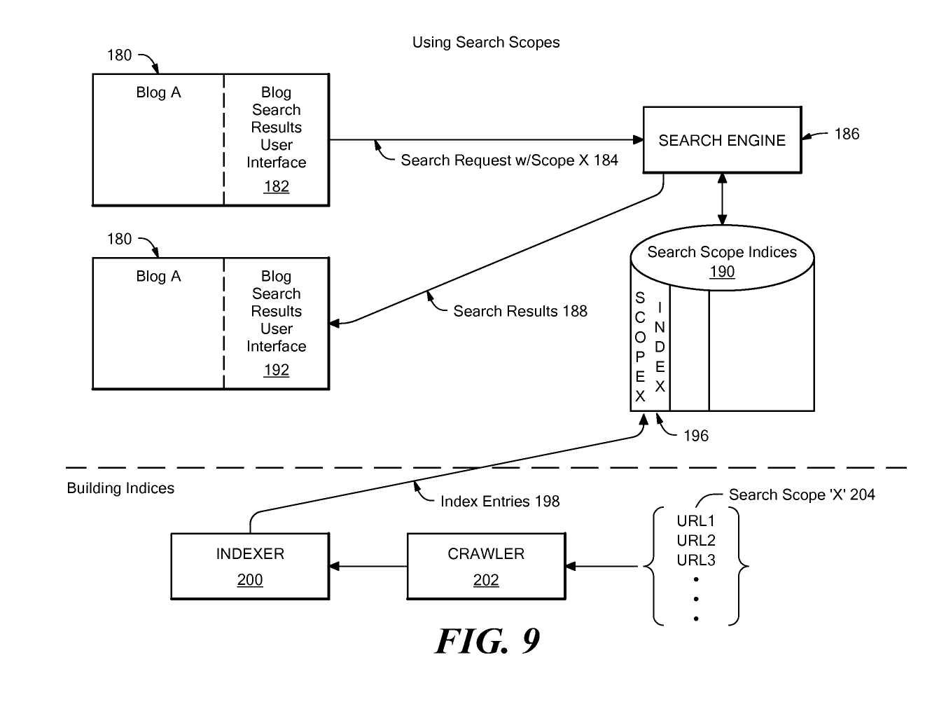

FIG. 9 is a block diagram further illustrating components in and operation of an embodiment of the disclosed system. As shown in FIG. 9, the disclosed system may be embodied such that a Weblog Blog A 180 includes a Blog Search Request user interface 182 that enables a user to select a search scope X that is specific to Blog A 180, and that was defined by an author of Blog A 180. The Blog Search Request user interface 182 further allows the user to issue a search request 184 with search scope X that is passed to a search engine 186. Any specific type of search engine may be used for search engine 186, which provides the software and algorithms operable to perform a search. For example, a Web site containing search engine 186 may be provided that also maintains search scope indices 190. The search scope indices 190 are search indices corresponding to individual Weblog specific, Weblog author defined search scopes, such as the search index 196, which corresponds to search scope X.

In order to build search index 196 for search scope X, an indexer program 200 generates index entries 198 based on the output of a Web crawler program 202, which searches through all documents indicated as being within search scope X. The documents associated with search scope X may, for example, be identified by the crawler program 202 using URLs 204 that were associated with search scope X by an author of Blog A 180. The crawler program 202 searches the documents within search scope X for specified keywords, and returns a list of only those of the documents in which the keywords were found. The indexer 200 then uses the list of documents in which the keywords were found to form index entries 198, which are passed to search scope indices 190 to be used as part of the index 196 associated with search scope X.

The search engine 186 processes the search request 184 based on the contents of the index 196, which corresponds to the search scope X, in order to identify the documents matching the query term or terms of the search request 184 within the search scope X. The search results 188 indicate those documents within search scope X identified by the search engine 186 as matching the query terms, and are passed back to Blog A 180 to be displayed through a Blog Search Results user interface 192 included in Blog A 180. The user interface 192 may be embodied through a document list, or any other appropriate user interface construct.

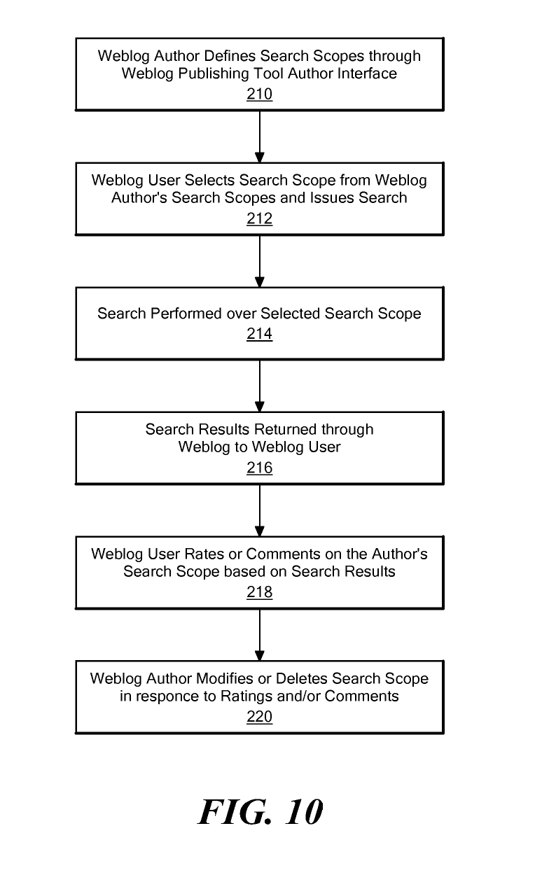

FIG. 10 is a flow chart illustrating steps performed by an embodiment of the disclosed system. At step 210, a Weblog author defines one or more search scopes for the Weblog he or she authors, for example through a Weblog Publishing Tool Author user interface. The search scopes defined at step 210 are specific to a given Weblog for which the user is an author user. For example, a Weblog author may access an author user interface to a given Weblog by performing one or more authentication steps required by the Weblog Publishing Tool to establish that he or she is in fact an author user with privileges allowing access to the Author user interface for that Weblog. Such steps may include providing the user's authentication credentials, such as a user name and password, which the system uses to authenticate the user as an author of the Weblog.

At step 212, a reading user of the Weblog accessed at step 210 selects the search scope defined at step 210, for example through a search scope interface provided through the Weblog. The search interface accessed by the user at step 212 is not part of the Weblog Author user interface accessed at step 210, but rather is part of the ordinary user interface used by non-author users to read the Weblog. Such a user interface may, for example, be accessed by any user without providing any author credentials, or may be accessed only by members of an enterprise or business organization that controls the Weblog, or by some other group of users. Further at step 212, the Weblog reading user issues a search using the selected search scope by providing one or more terms to be searched for in the set of content associated with the selected search scope.

At step 214, the disclosed system performs a search for documents based on the search scope selected at step 212. The search performed at step 214 may, for example, be performed using a dedicated search index corresponding to the search scope selected at step 212. Based on the search performed at step 214, the disclosed system returns search results at step 216 through a search results user interface, such as a document list, pop up window, or other specific user interface, provided as part of or through the reading user interface to the Weblog.

At step 218 the user that issued the search performed at step 214 may provide a rating and/or comment for the search scope selected at step 212. For example, the user having performed a search using the search scope selected at step 212 might enter a rating reflecting how well the results of the search performed at step 214 match the user's needs. Accordingly, a relatively high rating provided by the user might indicate the user's relative satisfaction with the search results returned at step 216. Conversely, if the results provided at step 216 did not meet the user's needs, then the search scope rating entered at step 218 might be relatively lower.

The disclosed system may be embodied to collect such search scope ratings for the Weblog specific, Weblog author defined search scopes it provides. The collected search scope ratings may then be provided to Weblog users in order to guide them in selecting from among multiple such Weblog specific, Weblog author defined search scopes for their own searches.

At step 220, the Weblog author can inspect the cumulative ratings for the search scopes they have defined, and then modify or delete existing search scopes, or create new ones for their Weblog.

Those skilled in the art will recognize that the specific order of steps shown in FIG. 10 is for purposes of explanation only, and that the disclosed system may be embodied and/or operated using a different order of steps. Moreover, the disclosed system is not limited to embodiments including all of the steps shown in FIG. 10, and some of the steps may be omitted in a given embodiment.

FIGS. 11 through 16 illustrate the disclosed method and system for providing subscriptions to search scopes. FIG. 11 shows a Feed Reader User Interface 230, as may be provided to a user that has subscribed to one or more search scopes through an embodiment of the disclosed system. The Feed Reader User Interface 230 may, for example, be a graphical user interface provided by an application program executing on the Weblog User Client Computer System 20 of FIG. 1. As shown in FIG. 11, the Feed Reader Interface 230 includes a Subscription List 236 indicating a number of content feeds to which the user has previously subscribed. In the example of FIG. 11, the user has selected SearchScope A 238 from the list 236, for example by clicking on SearchScope A 238 using a mouse. As a result of SearchScope A 238 being the currently selected content feed, the Feed Reader User Interface 230 shows a list of events 240 associated with the content feed SearchScope A 238. In the example of FIG. 11, the event 241 has been selected within the list 240, for example by the user clicking on the event 241. As a result of the user clicking on the event 241, event details information 242 associated with the event 241 is also displayed in the Feed Reader User Interface 230. Since the event 241 is a modification of SearchScope A 238, the information 242 indicates the modifications performed on SearchScope A 238, which include the addition of the content contained at www.company-online.com to the search scope, and the removal of the content indicated by https:/33.4.55.555/application/ from the search scope.

While the events shown in the subscription event list 240 include modification and statistic summary events, those skilled in the art will recognize that any specific kind of event relating to a search scope may be provided in association with a subscription to the search scope. Moreover, while the Feed Reader User Interface 230 is one way that a user can access information provided through a subscription to a search scope as provided by the disclosed system, various other systems for accessing subscription information may alternatively used, such as those provided for accessing RSS, ATOM, and/or other types of feeds through a Web browser application program or the like.

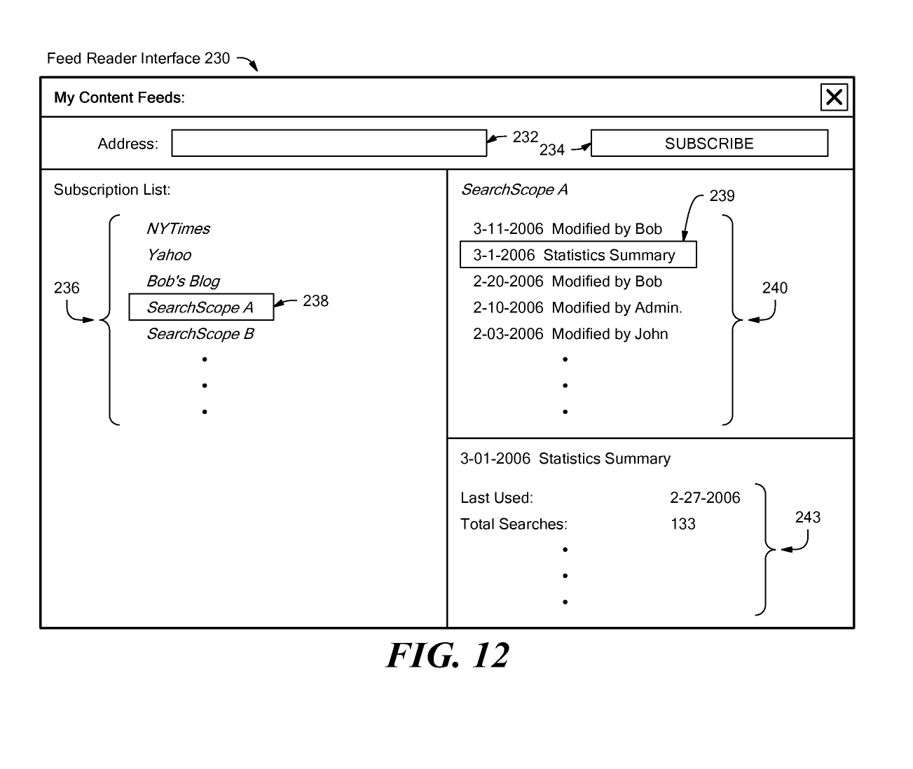

FIG. 12 shows the Feed Reader User Interface 230 of FIG. 11 after the user has caused a different subscription event to be selected. As shown in FIG. 12, the user has caused the event 239 to be selected, for example by clicking on the event 239 with the mouse. As a result of the event 239 having been selected, the Feed Reader User Interface 230 displays event details information 243. Since the event 239 is a statistics summary event, the information 243 includes statistics information regarding SearchScope A 238 that was collected on Mar. 1, 2006. For example, the information 243 is shown including a date that SearchScope A 238 was last used, and a total number of times that SearchScope A 238 had been used. The statistics shown in the information 243 are only provided for purposes of explanation, and those skilled in the art will recognize that any specific type of statistics may alternatively be provided, and that various content related to the search scope may be provided as part of the content feed for the search scope.

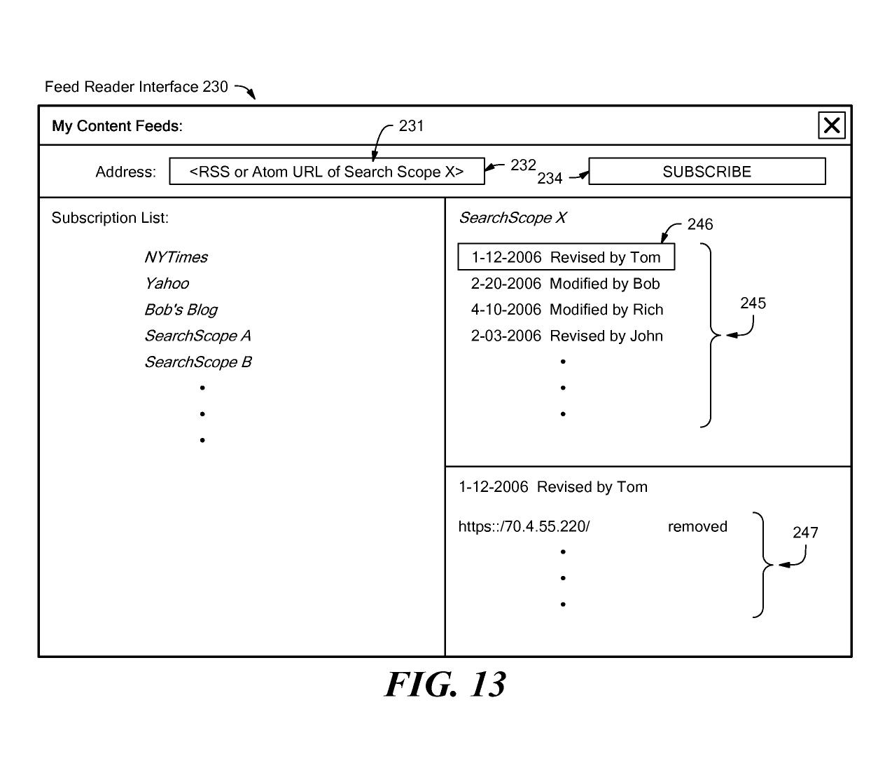

FIG. 13 shows the Feed Reader User Interface 230 after the user has copied the URL 231 (“<RSS or Atom URL of Search Scope X>”), which is a URL that points to a content feed for a search scope, into the Address field 232. The URL 231 may, for example, consist at least in part of XML (“eXtensible Markup Language”) code. As a result of the user copying URL 231 into the Address field 232, the Feed Reader User Interface 230 displays a list of subscription events 245 associated with the search scope content feed pointed to by the URL 231. In the example of FIG. 13, the events 245 include revisions and modification events associated with the search scope. Since the event 246 is currently selected, detail information 247 about the event 246 is shown in the Feed Reader User Interface 230, including that the content indicated by https::/70.4.55.220/ was removed during that revision event.

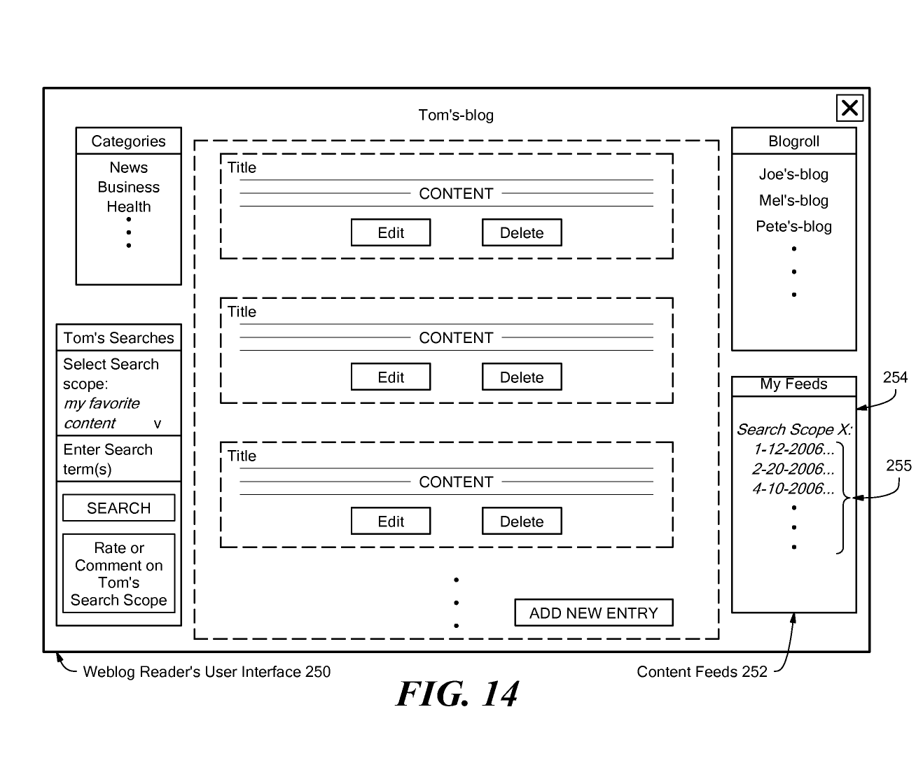

FIG. 14 shows a Weblog Reader's User Interface 250, as may be provided by an embodiment of the disclosed system. For example, the Weblog Reader's User Interface 250 may be provided to the Weblog Reading User 24 by one of the Weblogs 12 of FIG. 1. As shown in FIG. 14, a Content Feeds feature 252 of the Weblog providing the User Interface 250 includes at least one entry for a search scope to which the Weblog author has subscribed, shown for purposes of illustration as the Search Scope X 254. The Content Feeds feature 252 displays entries for a number of content subscriptions of the author of the Weblog providing the User Interface 250, including the entry 254. In the example of FIG. 14, the entry 254 includes indications 255 of events associated with the content subscription for the entry 254. For example, the indications 255 are each shown to be of dated events associated with the Search Scope X, to which the author of the Weblog providing the User Interface 250 has subscribed.

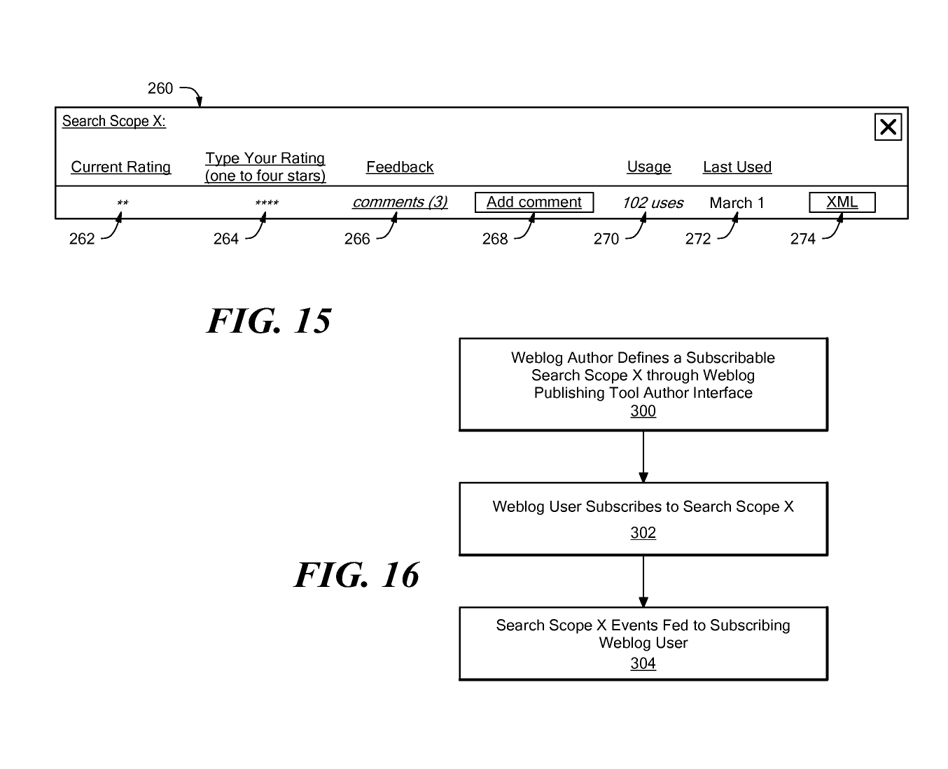

FIG. 15 is an example user interface pop-up window 260 provided in response to a user clicking on or otherwise selecting a subscribable search scope Search Scope X. For example, the pop-up window 260 may be provided by an embodiment of the disclosed system in response to a user clicking on one of the entries 240 shown in FIG. 12, or on some other indication of an event associated with a subscribable search scope, or on the name of a subscribable search scope within a user interface provided by the disclosed system. In the pop-up window 260 of FIG. 15, a column 262 shows a current rating of the subscribable search scope, a column 264 allows the user to type in their rating of the subscribable search scope, a column 266 shows the number of comments posted with regard to the subscribable search scope and allows the user to read those existing comments, and a column 268 enables the user to add a comment regarding the subscribable search scope. A column 270 shows the number of times the subscribable search scope has been used to perform a search, and a column 272 shows the date on which the subscribable search scope was last used. A button 274 enables the user to subscribe to the subscribable search scope. For example, in the illustrative pop-up window 260, when the user clicks on the button 274 a URL is presented to the user that can be copied and pasted into the address field 232 as shown in FIG. 11. As a result, the user is subscribed to the Search Scope X. The URL presented as a result of clicking on the button 274 provides an RSS feed regarding Search Scope X. The RSS feed regarding Search Scope X consists of summaries of events relating to Search Scope X, such as modifications to Search Scope X, that are published to subscribing users, for example in RSS format for download. Alternatively, the disclosed system may be embodied such that clicking on a button in the column 274 automatically causes a subscription to the RSS feed for Search Scope X to be created, without requiring the user to cut and paste a URL.

FIG. 16 is a flow chart illustrating steps performed in one embodiment of the disclosed system for providing a search scope subscription. At step 300, a Weblog Author defines a subscribable Search Scope X through a Weblog Publishing Tool Author Interface, such as the user interface 30 shown in FIG. 1. At step 302, a Weblog user subscribes to the content feed associated with Search Scope X, for example through the user interface 81 shown in FIG. 4, or through the user interface 120 shown in FIG. 6. At step 304, events associated with Search Scope X are fed to the user that subscribed to the content feed in step 302, for example through feed reader application or some other mechanism.

The figures include block diagram and flowchart illustrations of methods, apparatus(s) and computer program products according to an embodiment of the invention. It will be understood that each block in such figures, and combinations of these blocks, can be implemented by computer program instructions. These computer program instructions may be loaded onto a computer or other programmable data processing apparatus to produce a machine, such that the instructions which execute on the computer or other programmable data processing apparatus create means for implementing the functions specified in the block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block or blocks.

Those skilled in the art should readily appreciate that programs defining the functions of the present invention can be delivered to a computer in many forms; including, but not limited to: (a) information permanently stored on non-writable storage media (e.g. read only memory devices within a computer such as ROM or CD-ROM disks readable by a computer I/O attachment); (b) information alterably stored on writable storage media (e.g. floppy disks and hard drives); or (c) information conveyed to a computer through communication media for example using wireless, baseband signaling or broadband signaling techniques, including carrier wave signaling techniques, such as over computer or telephone networks via a modem.

While the invention is described through the above exemplary embodiments, it will be understood by those of ordinary skill in the art that modification to and variation of the illustrated embodiments may be made without departing from the inventive concepts herein disclosed. Moreover, while the preferred embodiments are described in connection with various illustrative graphical user interface constructs, one skilled in the art will recognize that they may be embodied using a variety of specific graphical user interfaces.

I claim:

1. A method of defining search scopes provided through a Weblog, comprising:
providing a Weblog author user interface accessible only to at least one Weblog author user associated with said Weblog, wherein said Weblog author user interface enables said Weblog author to enter postings into said Weblog, and wherein said Weblog author user interface further includes a search scope definition interface that allows said Weblog author user to define at least one Weblog-specific search scope, and wherein said search scope definition interface allows said Weblog author user to indicate specific content to be associated with said Weblog-specific search scope;
providing a search interface within said Weblog to a Weblog reading user, wherein said search interface enables said Weblog reading user to perform a search across said at least one Weblog-specific search scope defined by said Weblog author user; and
performing said search across said at least one Weblog-specific search scope defined by said Weblog author user, wherein said performing said search across said at least one Weblog-specific search scope includes searching said specific content associated with said Weblog-specific search scope specified by said Weblog author user.

2. The method of claim 1, further comprising providing a search scope rating interface within said Weblog to said Weblog reading user, wherein said search scope rating interface enables said Weblog reading user to indicate a rating of said Weblog-specific search scope.

3. The method of claim 2, wherein said search scope rating interface further displays a current rating of said Weblog specific search scope, and wherein said current rating reflects previously received user ratings of said Weblog-specific search scope.

4. The method of claim 3, further comprising:
wherein said search scope definition interface allows said Weblog author user to define a plurality of Weblog-specific search scopes, and wherein said search scope definition interface allows said Weblog author user to indicate specific content to be associated with each of said Weblog-specific search scopes;
wherein said search interface enables said Weblog reading user to select one of said plurality of Weblog-specific search scopes with which to perform a search across said at least one Weblog-specific search scope defined by said Weblog author user for said one of said plurality of Weblog-specific search scopes;
wherein said search scope rating interface enables said Weblog reading user to indicate a rating for each of said plurality of Weblog-specific search scopes; and
wherein said search scope rating interface displays a current rating of each of said plurality of Weblog-specific search scopes.

5. The method of claim 1, wherein said search scope definition interface allows said Weblog author user to define said Weblog-specific search scopes by providing at least one uniform resource locator indicating said specific content to be associated with said Weblog-specific search scopes.

6. The method of claim 1, wherein said search scope definition interface allows said Weblog author user to define said Weblog-specific search scopes by identifying at least Weblog feature indicating said specific content to be associated with said Weblog-specific search scopes.

7. The method of claim 6, wherein said Weblog feature comprises a blogroll feature of said Weblog indicating at least one other Weblog.

8. The method of claim 1, further comprising maintaining a search scope specific search index associated with said Weblog-specific search scope.

9. A system including a computer readable medium, said computer readable medium having program code stored thereon for defining search scopes provided through a Weblog, said program code comprising:
program code for providing a Weblog author user interface accessible only to at least one Weblog author user associated with said Weblog, wherein said Weblog author user interface enables said Weblog author to enter postings into said Weblog, and wherein said Weblog author user interface further includes a search scope definition interface that allows said Weblog author user to define at least one Weblog-specific search scope, and wherein said search scope definition interface allows said Weblog author user to indicate specific content to be associated with said Weblog-specific search scope;
program code for providing a search interface within said Weblog to a Weblog reading user, wherein said search interface enables said Weblog reading user to perform a search across said at least one Weblog-specific search scope defined by said Weblog author user; and
program code for performing said search across said at least one Weblog-specific search scope defined by said Weblog author user, wherein said performing said search across said at least one Weblog-specific search scope includes searching said specific content associated with said Weblog-specific search scope specified by said Weblog author user.

10. The system of claim 9, said program code further comprising:
program code for providing a search scope rating interface within said Weblog to said Weblog reading user, wherein said search scope rating interface enables said Weblog reading user to indicate a rating of said Weblog-specific search scope.

11. The system of claim 10, wherein said search scope rating interface further displays a current rating of said Weblog specific search scope, and wherein said current rating reflects previously received user ratings of said Weblog-specific search scope.

12. The system of claim 11, further comprising:
wherein said search scope definition interface allows said Weblog author user to define a plurality of Weblog-specific search scopes, and wherein said search scope definition interface allows said Weblog author user to indicate specific content to be associated with each of said Weblog-specific search scopes;
wherein said search interface enables said Weblog reading user to select one of said plurality of Weblog-specific search scopes with which to perform a search across said at least one Weblog-specific search scope defined by said Weblog author user for said one of said plurality of Weblog-specific search scopes;
wherein said search scope rating interface enables said Weblog reading user to indicate a rating for each of said plurality of Weblog-specific search scopes; and
wherein said search scope rating interface displays a current rating of each of said plurality of Weblog-specific search scopes.

13. The system of claim 9, wherein said search scope definition interface allows said Weblog author user to define said Weblog-specific search scopes by providing at least one uniform resource locator indicating said specific content to be associated with said Weblog-specific search scopes.

14. The system of claim 9, wherein said search scope definition interface allows said Weblog author user to define said Weblog-specific search scopes by identifying at least Weblog feature indicating said specific content to be associated with said Weblog-specific search scopes.

15. The system of claim 14, wherein said Weblog feature comprises a blogroll feature of said Weblog indicating at least one other Weblog.

16. The system of claim 9, further comprising program code for maintaining a search index associated with said Weblog-specific search scope.

17. A computer program product including a computer readable medium, said computer readable medium having program code for defining search scopes provided through a Weblog stored thereon, said program code comprising:
program code for providing a Weblog author user interface accessible only to at least one Weblog author user associated with said Weblog, wherein said Weblog author user interface enables said Weblog author to enter postings into said Weblog, and wherein said Weblog author user interface further includes a search scope definition interface that allows said Weblog author user to define at least one Weblog-specific search scope, and wherein said search scope definition interface allows said Weblog author user to indicate specific content to be associated with said Weblog-specific search scope;
program code for providing a search interface within said Weblog to a Weblog reading user, wherein said search interface enables said Weblog reading user to perform a search across said at least one Weblog-specific search scope defined by said Weblog author user; and
program code for performing said search across said at least one Weblog-specific search scope defined by said Weblog author user, wherein said performing said search across said at least one Weblog-specific search scope includes searching said specific content associated with said Weblog-specific search scope specified by said Weblog author user.

18. A computer data signal embodied in a carrier wave, said computer data signal having program code stored thereon for defining search scopes provided through a Weblog, said program code comprising:
program code for providing a Weblog author user interface accessible only to at least one Weblog author user associated with said Weblog, wherein said Weblog author user interface enables said Weblog author to enter postings into said Weblog, and wherein said Weblog author user interface further includes a search scope definition interface that allows said Weblog author user to define at least one Weblog-specific search scope, and wherein said search scope definition interface allows said Weblog author user to indicate specific content to be associated with said Weblog-specific search scope;
program code for providing a search interface within said Weblog to a Weblog reading user, wherein said search interface enables said Weblog reading user to perform a search across said at least one Weblog-specific search scope defined by said Weblog author user; and
program code for performing said search across said at least one Weblog-specific search scope defined by said Weblog author user, wherein said performing said search across said at least one Weblog-specific search scope includes searching said specific content associated with said Weblog-specific search scope specified by said Weblog author user.

19. A system for defining search scopes provided through a Weblog, comprising:
means for providing a Weblog author user interface accessible only to at least one Weblog author user associated with said Weblog, wherein said Weblog author user interface enables said Weblog author to enter postings into said Weblog, and wherein said Weblog author user interface further includes a search scope definition interface that allows said Weblog author user to define at least one Weblog-specific search scope, and wherein said search scope definition interface allows said Weblog author user to indicate specific content to be associated with said Weblog-specific search scope;
means for providing a search interface within said Weblog to a Weblog reading user, wherein said search interface enables said Weblog reading user to perform a search across said at least one Weblog-specific search scope defined by said Weblog author user; and
means for performing said search across said at least one Weblog-specific search scope defined by said Weblog author user, wherein said performing said search across said at least one Weblog-specific search scope includes searching said specific content associated with said Weblog-specific search scope specified by said Weblog author user.

20. A method of providing an electronic subscription to information associated with a search scope, comprising:
generating a graphical user interface providing an indication of at least one search scope; and
wherein said graphical user interface further includes a user interface mechanism enabling a user to subscribe to a content feed associated with said search scope.

21. The method of claim 20, wherein said user interface mechanism enabling said user to subscribe to said content feed associated with said search scope comprises a button providing access to a pointer to said content feed, wherein said pointer can be copied and pasted.

22. The method of claim 21, wherein said content feed includes indication of at least one modification to said search scope.

23. The method of claim 22, wherein said content feed includes indication of at least one usage statistic reflecting use of said search scope to perform searches.

24. The method of claim 23, wherein said usage statistic comprises a total number of times said search scope has been used to perform a search.

25. The method of claim 23, wherein said usage statistic comprises an indication of a last time said search scope was used to perform a search.

26. A system including a computer readable medium, wherein said computer readable medium has stored thereon program code for providing an electronic subscription to information associated with a search scope, said program code comprising:
program code for generating a graphical user interface providing an indication of at least one search scope; and
program code for generating a user interface mechanism in said graphical user interface enabling a user to subscribe to a content feed associated with said search scope.

27. The system of claim 26, wherein said user interface mechanism enabling said user to subscribe to said content feed associated with said search scope comprises a button providing access to a pointer to said content feed, wherein said pointer can be copied and pasted.

28. The system of claim 27, wherein said content feed includes indication of at least one modification to said search scope.

29. The system of claim 28, wherein said content feed includes indication of at least one usage statistic reflecting use of said search scope to perform searches.

30. The system of claim 29, wherein said usage statistic comprises a total number of times said search scope has been used to perform a search.

31. The method of claim 29, wherein said usage statistic comprises an indication of a last time said search scope was used to perform a search.
